(19) United States
(12) Patent Application Publication
(10) Pub. No.: US 2013/0164973 A1
(43) Pub. Date: Jun. 27, 2013

(54) PANEL MOUNT ELECTRICAL CONNECTOR

(71) Applicant: Hung Viet Ngo, Austin, TX (US)

(72) Inventor: Hung Viet Ngo, Austin, TX (US)

(21) Appl. No.: 13/693,431

(22) Filed: Dec. 4, 2012

Related U.S. Application Data
(60) Provisional application No. 61/579,045, filed on Dec. 22, 2011.

(51) Int. Cl. H01R 13/74

(52) U.S. Cl. CPC H01R 13/743
USPC 439/540.1

(57) ABSTRACT

In accordance with one embodiment, a panel mount electrical connector can include a connector housing configured to be inserted into an opening in a panel. The electrical connector can include at least one first retention member in the form of a spacer member supported by the connector housing and configured to be removably coupled to the connector housing. The at least one spacer member can have a spacer thickness that at least partially defines a gap between the spacer member and at least one second retention member, the gap sized to receive a panel of a predetermined thickness. The panel mount electrical connector can further include a locking member supported by the connector housing, the locking member configured to prevent removal of the panel mount electrical connector from a panel when the locking member is in the locked position.

### CROSS-REFERENCE TO RELATED APPLICATIONS

This application claims priority to U.S. Provisional Application Ser. No. 61/579,045, filed Dec. 22, 2011, the contents of which are hereby incorporated by reference herein.

### BACKGROUND

Electrical connectors can be provided as panel mount electrical connectors configured to attach to panels. However, a typical panel mount electrical connector is configured to attach only to panels having a particular predetermined thickness. Thus, multiple panel mount electrical connectors may be needed if it is desirable to mount electrical connectors to panels of different thicknesses.

### SUMMARY

In accordance with one embodiment, an electrical connector can be configured to be coupled to a panel that defines an opening. The electrical connector can include a connector housing that is configured to be inserted along an insertion direction at least partially into the opening to thereby define an inserted position. The connector housing can define a mating end, a mounting end, and opposed surfaces that extend between the mating end and the mounting end. The connector housing can include at least one first retention member that extends from at least one of the opposed surfaces. The electrical connector can further include at least one second retention member that is configured to be removably coupled to the connector housing such that the first and second retention members are spaced from each other along the insertion direction to thereby define a gap that is sized to capture the panel between the first and second retention members when the connector housing is in the inserted position.

In another embodiment, an electrical connector can be configured to be coupled to a panel that defines an opening. The electrical connector can include a connector housing that is configured to be inserted into the opening of the panel along an insertion direction so as to define an inserted position. The connector housing can define opposed surfaces that are spaced from each other along a direction that is perpendicular to the insertion direction. The connector housing can include at least one first retention member that extends from at least one of the opposed surfaces. The electrical connector can further include at least one electrical contact supported by the connector housing, and at least one second retention member at least partially supported by the connector housing. The at least one second retention member can have a front face located at a position that is spaced from the first retention member along the insertion direction so as to define a gap from the front face to the first retention member. The gap can be sized to capture the panel between the front face and the first retention member when the connector housing is in the inserted position, wherein the position of the front face is adjustable so that the gap is correspondingly adjustable.

In another embodiment, an electrical connector can include a connector housing that is configured to be inserted along an insertion direction at least partially into the opening of the panel. The connector housing can define opposed surfaces that are spaced from each other along a direction that is perpendicular to the insertion direction. The connector housing can include at least one first retention member that extends from at least one of the opposed surfaces and at least one electrical contact supported by the connector housing. The electrical connector can further include a plurality of spacer members configured to be selectively coupled to the connector housing at the at least one of the opposed surfaces. Each of the plurality of spacer members can define an inner surface and an engagement surface that is spaced from the inner surface along the insertion direction when the spacer members are coupled to the at least one of the opposed surfaces. Each of the spacer members can define a thickness that extends from the inner surface to the engagement surface, and the thickness of at least a first one of the plurality of spacer members is different than the thickness of at least a second one of the plurality of spacer members, such that when the first one of the plurality of spacer members is coupled to the at least one of the opposed surfaces, a first gap is defined from the first retention member to the engagement surface of the first spacer member along the insertion direction, and when the second one of the plurality of spacer members is coupled to the at least one of the opposed surfaces, a second gap is defined from the first retention member to the engagement surface of the second spacer member along the insertion direction, the second gap different from the first gap.

In another embodiment, a method of mounting an electrical connector to a panel can include the steps of coupling a spacer member to an electrical connector housing such that an engagement surface of the spacer member is spaced from a first retention member along an insertion direction so as to define a desired gap; moving the electrical connector housing along the insertion direction into an opening defined by a panel so as to define an inserted position; and moving the electrical connector housing along a locking direction that is perpendicular to the insertion direction from the inserted position to a locking position to thereby trap the panel within the desired gap between the first retention member and the engagement surface.

The method can further include the steps of coupling a first spacer member to the electrical connector housing such that the engagement surface of the first spacer member is spaced from the first retention member along the insertion direction so as to define a first gap; removing the first spacer member from the electrical connector housing; and coupling a second spacer member to the electrical connector housing such that the engagement surface of the second spacer member is spaced from the first retention member along the insertion direction so as to define a second gap that has a dimension along the insertion direction that is different than that of the first gap.

The method can further include the step of inserting a locking member into the opening of the panel so as to prevent the electrical connector housing from moving from the locked position toward the inserted position.

The first moving step comprises moving the electrical connector along the insertion direction such that a retention tab that extends from the first retention member passes through a slot defined by the panel.

In another embodiment, a method of mounting an electrical connector to a panel can include the steps of (i) providing an electrical connector having a connector housing and at least one electrical contact supported by the connector housing, at least one first retention member, and a plurality of second retention members each configured to be removably coupled to the connector housing, wherein at least a first one of the plurality of second retention members defines a first gap with respect to the first retention member when the at least a first one of the plurality of second retention members is coupled to the connector housing, and at least a second one of the plurality of second retention members defines a second gap with respect to the first retention member when the at least a second one of the plurality of second retention members is coupled to the connector housing, wherein the first gap is less than a thickness of the panel and the second gap is at least equal to the thickness of the panel; (ii) teaching the step of coupling the at least a second one of the plurality of second retention members to the connector housing so as to define the second gap between the at least one first retention member and the at least a second one of the plurality of second retention members; and (iii) teaching the step of mounting the electrical connector to the panel such that the panel is captured in the second gap.

### BRIEF DESCRIPTION OF THE DRAWINGS

The foregoing summary, as well as the following detailed description of an example embodiment of the application, will be better understood when read in conjunction with the appended drawings, in which there is shown in the drawings example embodiments for the purposes of illustration. It should be understood, however, that the application is not limited to the precise arrangements and instrumentalities shown. In the drawings:

FIG. 1A is a perspective view of an electrical connector assembly including a panel mount electrical connector removably attached to a panel in accordance with an embodiment. The illustrated panel mount electrical connector includes a connector housing having a connector body, a plurality of retention members, and a locking member;

FIG. 1B is a perspective exploded view of the panel mount electrical connector illustrated in FIG. 1A;

FIG. 1C is a perspective view of the rear end of the panel mount electrical connector illustrated in FIG. 1A;

FIG. 1D is a perspective view of a portion of the rear end of the connector housing of the panel mount electrical connector illustrated in FIG. 1A;

FIG. 2 is a perspective view of a spacer member configured to be removably coupled to the connector body of the panel mount electrical connector illustrated in FIG. 1A;

FIG. 3 is a perspective view of an example panel that the panel mount electrical connector illustrated in FIG. 1A can be removably attached to;

FIG. 4A is a perspective view of a locking member of the panel mount electrical connector illustrated in FIG. 1A;

FIG. 4B is a perspective section view of the locking member illustrated in FIG. 4A disposed within the connector housing of the panel mount electrical connector;

FIG. 5A is a front elevation view of the panel mount electrical connector illustrated in FIG. 1A, inserted into the panel illustrated in FIG. 3 and operated to an inserted position relative to the panel;

FIG. 5B is a perspective view of the rear end of the panel mount electrical connector in an inserted position relative to the panel, as illustrated in FIG. 5A;

FIG. 6A is a front elevation view of the panel mount electrical connector illustrated in FIG. 1A, inserted into the panel illustrated in FIG. 3 after the panel mount electrical connector has been operated from the inserted position into a retained position relative to the panel;

FIG. 6B is a perspective view of the rear end of the panel mount electrical connector in a retained position relative to the panel, as illustrated in FIG. 6A;

FIG. 6C is a perspective view of the front end of the panel mount electrical connector in a retained position relative to the panel, with the locking member in the released position relative to the connector housing and the panel; and

FIG. 6D is a perspective view of the front end of the panel mount electrical connector in the retained position relative to the panel, with the locking member in the locked position relative to the connector housing and the panel.

### DETAILED DESCRIPTION

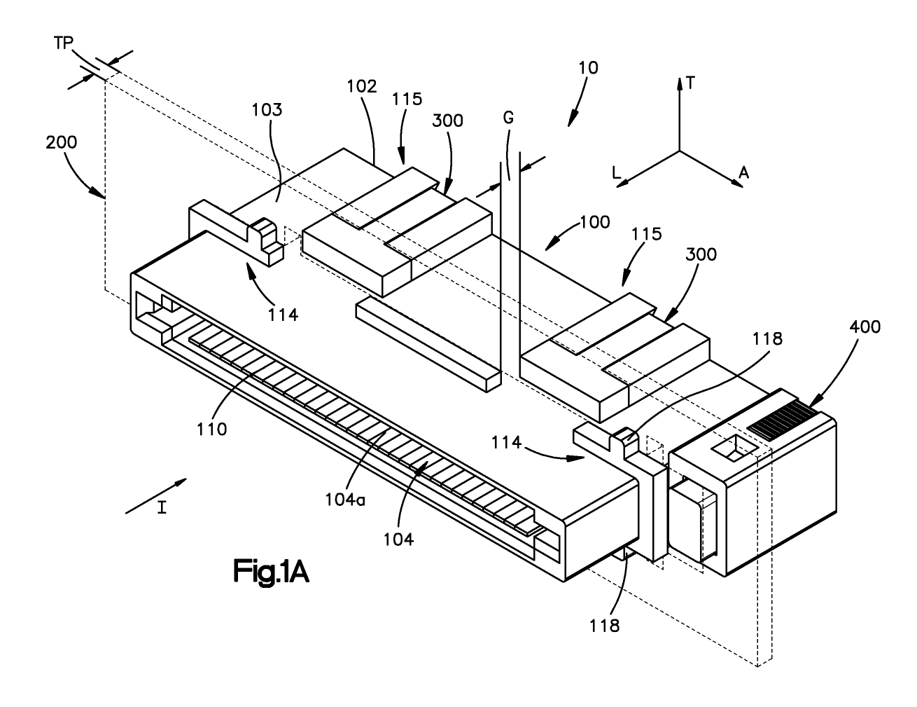

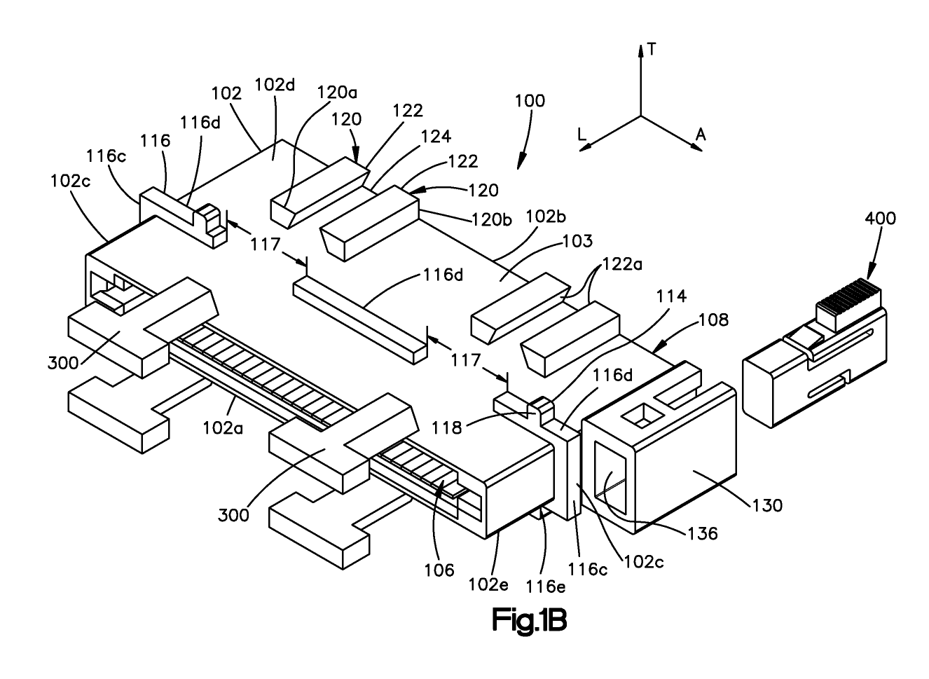

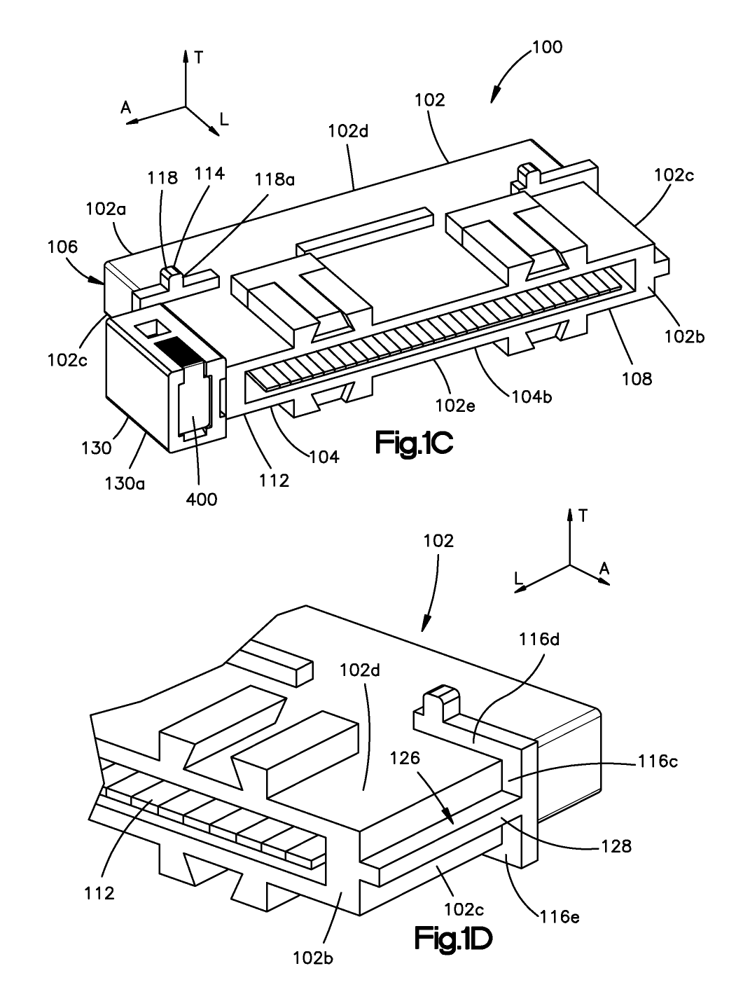

Referring initially to FIGS. 1A-1D, an electrical connector assembly 10 can include a panel mount electrical connector 100 and a panel 200. The panel mount electrical connector 100 is configured to be inserted into, and removably attached to, a panel 200. In accordance with the illustrated embodiment, the panel mount electrical connector 100 includes a connector housing 102 and at least one electrical contact 104 such as a plurality of electrical contacts 104 supported by the connector housing 102. The connector housing 102 can be electrically insulative, and made for instance from any suitable dielectric material. The connector housing 102 can include a housing body 103 that is generally rectangular shaped and defines a front, or mating, end 102a, an opposed back, or mounting, end 102b that is spaced from the mating end 102a along a longitudinal direction L, and opposed first and second sides 102c that are spaced from each other along a lateral direction A that extends substantially perpendicular to the longitudinal direction L. The first and second sides 102c can extend between the mating end 102a and the mounting end 102b. The illustrated connector housing 102 is elongate between the side ends 102c along the lateral direction A. The illustrated connector housing 102 and in particular the housing body 103 further defines an upper surface 102d and an opposed lower surface 102e, the upper and lower surfaces 102d, 102e are spaced from each other along a transverse direction T that is substantially perpendicular to both the lateral direction A and the longitudinal direction L.

In accordance with the illustrated embodiment and in reference to FIGS. 1A and 3, the panel 200 includes a panel body 201 that defines a first or front surface 200a and an opposed second or rear surface 200b spaced from each other along the longitudinal direction L so as to define a panel thickness TP. The panel 200 defines a panel opening 202 that can extend through the panel body 201 from the front surface 200a through the rear surface 200b. For instance, the panel opening 202 can be enclosed by an inner perimeter of the panel body 201, or can be open at one or more sides as desired. In accordance with the illustrated embodiment, the panel mount electrical connector 100 can include at least one first retention member 114 and at least one second retention member 115 that cooperate so as to capture the panel therebetween, and at least one locking member 400 supported by the connector housing 102 and configured to releasably lock the panel 200 between the first and second retention members 114 and 115.

The connector housing 102 can be configured to support a plurality of electrical contacts 104, and can define a mating interface 106 proximate the mating end 102a, and a mounting interface 108 proximate the mounting end 102b. The electrical contacts 104 of the plurality can be spaced from each other along a row direction that is substantially parallel to the lateral direction A. The connector housing 102 can be overmolded onto the electrical contacts 104. Alternatively, the electrical contacts 104 can be stitched into the connector housing 102, or otherwise supported by the connector housing 102 as desired. Each electrical contact 104 of the plurality of electrical contacts 104 includes a main body portion, a mating end 104a defined at a proximal end of the main body portion and configured to electrically connect to a first complementary electrical component, and a mounting end 104b defined at an opposed distal end of the main body portion and configured to electrically connect to a second complementary electrical component. It should be appreciated that the connector housing 102 can be made from any suitable dielectric material unless otherwise specified, and that the electrical contacts 104 can be made from any suitable conductive material unless otherwise specified.

The mating and mounting interfaces 106, 108 can be configured to electrically connect to complementary electrical components. The illustrated connector housing 102 defines a mating cavity 110 that extends into the mating end 102a of the connector housing 102. The mating interface 106 can be defined in the mating cavity 110. The mating cavity 110 can be configured to at least partially receive a complementary electrical component inserted into the mating cavity 110 along an insertion direction I that can be substantially parallel to the longitudinal direction L. For example, in accordance with the illustrated embodiment, the mating ends 104a of the plurality of electrical contacts 104 can be configured to receive an electrical contact of a first complementary electrical component, for instance respective contact pads affixed to the upper and/or lower surfaces of a printed circuit board, a blade contact of an electrical header connector, or the like. Accordingly, the electrical contacts 104 can be referred to as receptacle contacts and the panel mount electrical connector 100 can be referred to as a receptacle connector. It should be appreciated that the panel mount electrical connector 100 can alternatively be constructed as a header connector, for instance the plurality of electrical contacts 104 can be provided with contact blade mating ends 104a. It should further be appreciated that while the longitudinal and lateral directions are illustrated as extending along a horizontal plane, and that the transverse direction is illustrated as extending along a vertical plane, the planes that encompass the various directions may differ during use, depending, for instance, on the desired orientation of the panel mount electrical connector 100.

The illustrated connector housing 102 defines a mounting cavity 112 that extends into the mounting end 102b of the connector housing 102. The mounting interface 108 can be defined in the mounting cavity 112. The mounting cavity 112 can be configured to support one or more, such as a plurality of second complementary electrical components mounted to respective mounting ends 104b of the plurality of electrical contacts 104. For example, in accordance with the illustrated embodiment, the mounting ends 104b of each electrical contact 104 can be configured to be electrically connected to a respective wire supported by the connector housing 102. Accordingly, the panel mount electrical connector 100 can be referred to as a cable connector, and a first complementary electrical component, such as a printed circuit board, electrically connected to the mating interface 106 can be placed into electrical communication with the plurality of wires electrically connected to the mounting interface 108. Because the mounting interface 108 of the illustrated panel mount electrical connector 100 is oriented substantially parallel with respect to the mating interface 106, the panel mount electrical connector 100 can be referred to as a vertical electrical connector. It should be appreciated that the electrical contacts 104 can be alternatively constructed so as to define a mounting interface 108 that is oriented substantially perpendicular to the mating interface 106, such that the panel mount electrical connector 100 is provided as a right-angle electrical connector.

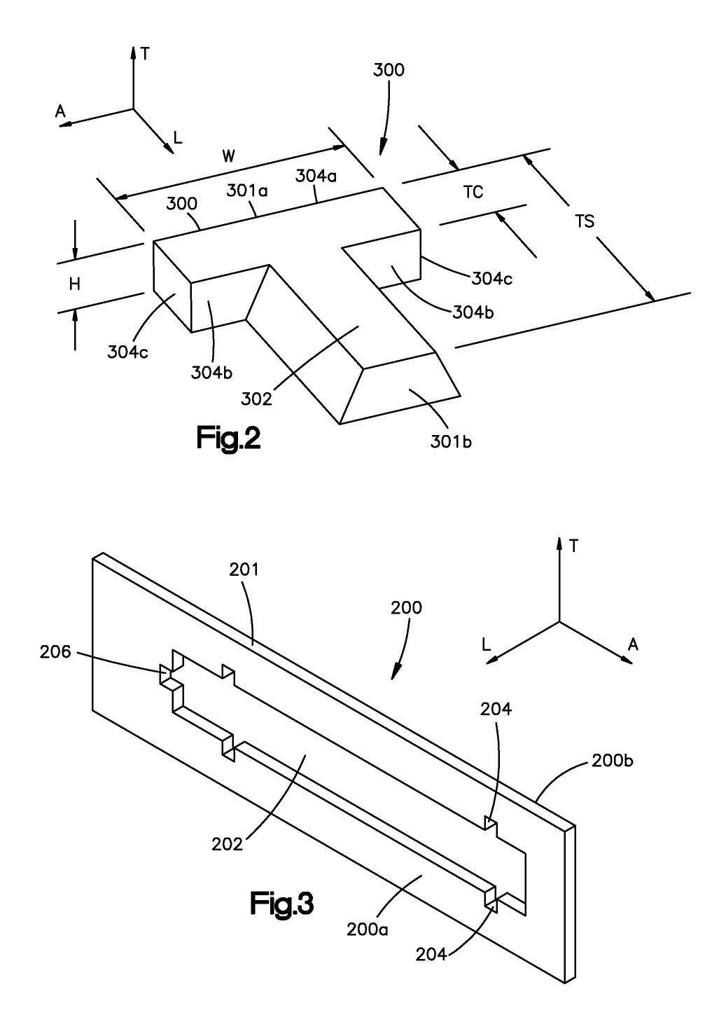

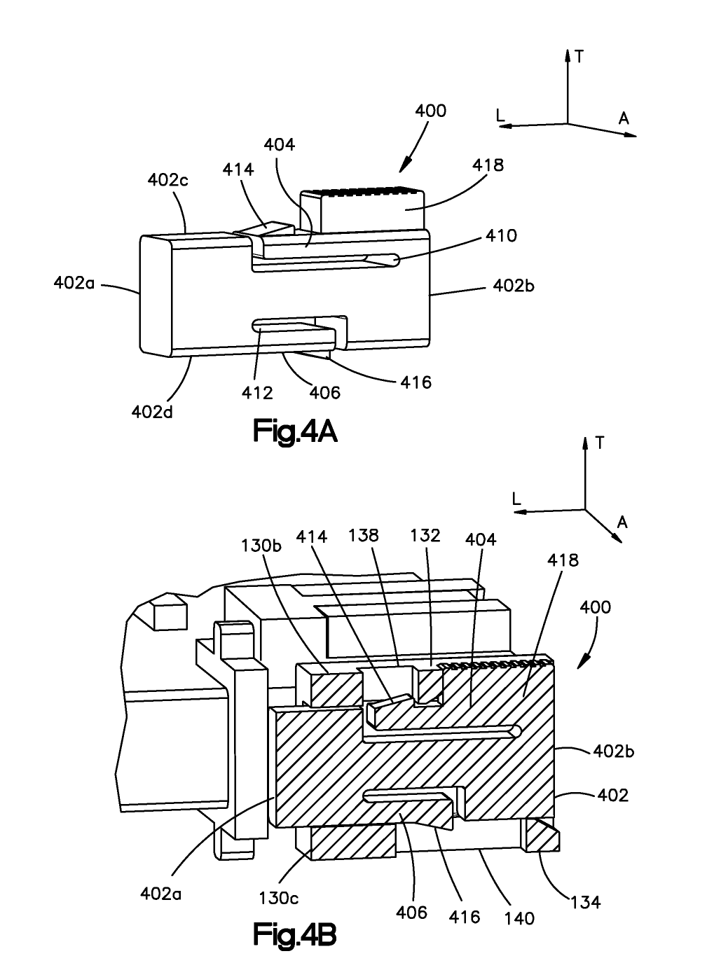

Referring now to FIGS. 1A-3, the panel mount electrical connector 100 can be configured to be inserted at least partially into the panel 200. The panel mount electrical connector 100 can further be removed from the panel 200 in accordance with the illustrated embodiment. Accordingly, it can be said that the panel mount electrical connector 100 can be removably attached to the panel 200. For example, the panel mount electrical connector 100, such as the connector housing 102, can be configured to be at least partially inserted along the insertion direction I into the opening 202 that extends through the panel body 201. In accordance with the illustrated embodiment, the opening 202 extends through the panel body 201 along the insertion direction I. The opening 202 can be sized such that the connector housing 102 can extend through the opening 202 so as to define an inserted position of the panel mount electrical connector 100 relative to the panel 200. In accordance with the illustrated embodiment, when the panel mount electrical connector 100 is in the inserted position relative to the panel 200, the panel mount electrical connector 100 can be moveable relative to the panel 200 along the lateral direction. Thus, in accordance with the illustrated embodiment, the panel mount electrical connector 100 can be moved along the lateral direction A within the opening 202 between respective inserted and retained positions relative to the panel 200. When the panel mount electrical connector 100 is in the inserted position relative to the panel 200, the panel mount electrical connector 100 can be removed from the panel 200 through the opening 202 along the longitudinal direction L. When the panel mount electrical connector 100 is in the inserted position relative to the panel 200, engagement between the panel mount electrical connector 100 and the panel 200, such as the panel body 201, prevents the panel mount electrical connector 100 from being removed from the panel 200 through the opening 202 along the longitudinal direction L, as described in more detail below.

The panel mount electrical connector 100 can include at least one, such as a pair of first retention members 114 configured to retain the panel 200 in a retained position relative to the panel mount electrical connector 100, though it should be appreciated that the panel mount electrical connector 100 can include any number of first retention members 114 as desired. The panel mount electrical connector 100 can include at least one or more retention members 114 that are fixed relative to the housing body 103 and at least one or more second retention members 115 that can be at least partially supported to the housing body 103. That is, each second retention member 115 can include a portion that is fixed to the housing body 103 and a portion that is removably coupled to the fixed portion. Therefore, the second retention member is partially supported when the removable portion is decoupled from the fixed portion and is fully supported when the removable portion is coupled to the fixed portion.

The first and second retention members 114 and 115 can be configured to retain the panel 200 in position relative to the panel mount electrical connector 100 by interfering with, or preventing, movement of the panel 200 and the connector housing 102 relative to each other along the longitudinal direction L. For instance, in accordance with the illustrated embodiment, when a force is applied to the panel mount electrical connector 100 and/or the panel 200 that causes one of the panel mount connector 100 and the panel to move with respect to the other, one or more of the retention members 114 can make contact with respective portions of the panel 200, such as the opposed front and/or rear surfaces 200a, 200b of the panel 200.

In accordance with the illustrated embodiment, the connector housing 102 can include a peripheral wall 116 that extends outwardly from the connector housing 102, the peripheral wall 116 is configured such that the outer edges of respective portions of the peripheral wall 116 present an interference fit relative to respective portions of the opening 202 in the panel 200 when the panel mount electrical connector 100 is inserted into the opening 202. The illustrated peripheral wall 116 is spaced rearward from the front end 102a of the connector housing, and includes upper wall portions 116d extending transversely upward from the upper surface 102d of the connector housing, opposed lower wall portions 116e extending transversely downward from the lower surface 102e of the connector housing, and opposed side wall portions 116c extending laterally from the side ends 102c of the connector housing.

In accordance with the illustrated embodiment, the upper wall 116d comprises three upper wall portions 116d and the lower wall 116e comprises three lower wall portions 116e. The upper and lower walls portions 116d, 116e can be constructed substantially identically. The upper wall 116d can define a first spacer gap 117 defined between the leftmost upper wall portion 116d and the center upper wall portion 116d, and a second spacer gap 117 defined between the center upper wall portion 116d and the rightmost upper wall portion 116d, the first and second spacer gaps 117 sized such that respective ones of the at least one second retention members 115 can fit through the spacer gaps 117, for instance during coupling of the at least one second retention member 115 to the housing body 103. Similarly, the lower wall 116e can define a first spacer gap 117 defined between the leftmost lower wall portion 116e and the center lower wall portion 116e, and a second spacer gap 117 defined between the center lower wall portion 116e and the rightmost lower wall portion 116e. The respective portions of the peripheral wall 116 can be integral relative to the connector body. Alternatively, the respective portions of the peripheral wall 116 can be attached to the connector body.

The panel mount electrical connector 100 can include at least one, such as a plurality of first retention members 114 that are fixed relative to, in other words restrained from moving with respect to, the connector housing 102. As shown, the upper and lower wall portions 116d and 116e can at least partially define the first retention members 114. Therefore it can be said that the at least one first retention member 114 extends from at least one of the opposed surfaces 102d and 102e. As shown, the connector housing can further include at least one retention tab 118 that extends out from the at least one first retention member 114 along a direction, such as the transverse direction T, that is substantially perpendicular to the insertion direction I. In accordance with the illustrated embodiment, the connector housing 102 includes at least two tabs 118 that project out relative to at least one or both of the upper surface 102d and an opposed lower surface 102e. The at least two tabs 118 can project out from at least one or both of the upper and lower surfaces 102d and 102e, or can project out from the upper wall portion 116d in accordance with the illustrated embodiment. Thus, a first one of the tabs 118 extends upward from the rightmost upper wall portion 116d, a second one of the tabs 118 extends downward from the rightmost lower wall portion 116e, a third one of the tabs 118 extends upward from the leftmost upper wall portion 116d, and a fourth one of the tabs 118 extends downward from the leftmost lower wall portion 116e.

The tabs 118 can be sized to present a clearance fit relative to corresponding upper and lower locating slots 204 defined by the opening 202 in the panel 200, the locating slots 204 configured to align, or key, the panel mount electrical connector in an inserted position relative to the panel 200, as described in more detail below. The illustrated tabs 118 are aligned along the transverse direction T, and are disposed on the rightmost and leftmost side ends 102c of the connector housing 102. The tabs 118 can be configured to prevent removal of the panel mount electrical connector from the panel 200. For instance each tab 118 can define a rear, or panel facing, surface 118a that is configured to make contact with a corresponding portion of the front surface 202a of the panel 200, for instance when a force is applied to the panel mount electrical connector 100 and/or the panel 200 that causes the panel mount electrical connector 100 to move rearward relative to the panel and/or causes the panel 200 to move forward relative to the panel mount electrical connector 100. In accordance with the illustrated embodiment, the panel facing surface 118a of the tabs can be substantially coplanar with the rear, or panel facing, surfaces of the respective wall portions of the peripheral wall 116. Therefore, the inner, or panel facing, surfaces of the peripheral wall 116 and the at least one first retention member 114, for instance the tabs 118, can define a first plane that is substantially parallel to a plane defined by the lateral and transverse directions. The first plane can be spaced along the longitudinal direction L from a second plane defined by the front, or panel facing surfaces of the at least one second retention member 115 that is substantially parallel to a plane defined by the lateral and transverse directions. The first plane can be substantially parallel to the first plane, and the distance along the longitudinal direction L between the first and second planes can define a gap G. It should be appreciated that the panel mount electrical connector 100 is not limited to the illustrated configuration of tabs 118, and that any other at least one first retention members 114 can alternatively be provided as desired. For example, in an alternative embodiment, the connector housing can define at least one first retention member in the form of a recess, the recess configured to receive a complementary tab defined in the opening 202 of the panel 200.

The panel mount electrical connector 100 can further include at least one, such as a plurality of second retention members 115 that are configured to be at least partially supported by the connector housing 102. In accordance with the illustrated embodiment, the at least one second retention member 115 can be configured to cooperate with the at least one first retention member 114 so as to retain the panel 200 in the gap G that is defined between the first and second retention members 114 and 115 along the insertion direction I. In accordance with the illustrated embodiment, the at least one first retention member 114 is disposed forward of the first surface 200a of the panel 200 when the connector housing 102 is inserted into the inserted position relative to the panel 200. Furthermore, in accordance with the illustrated embodiment, the at least one second retention member 115 is at least partially removably coupled to the connector housing 102. The second retention member 115 can be disposed rearward of the second surface 200b of the panel 200 when the connector housing 102 is in the inserted position. Accordingly, the first and second retention members 114 and 115 can be spaced from each other along the insertion direction I so as to define the gap G between the first and second retention members 114 and 115. The gap G can be sized at least equal to or greater than the thickness TP of the panel 200, such that the panel 200 is captured between the first and second retention members 114 and 115.

In accordance with the illustrated embodiment, the panel mount electrical connector 100 includes four second retention members 115 that each include a spacer member 300 that is configured to be removably coupled or otherwise supported by the connector housing 102, though it should be appreciated that the panel mount electrical connector 100 can include any number of second retention members 115 as desired. The illustrated connector housing 102 can be configured to support the spacer members 300. For example, each retention member 115 can include a support member 120 configured to receive and captively retain the spacer members 300 relative to the connector housing 102. The illustrated support members 120 comprise pairs of support blocks 122 that extend from the upper and lower surfaces 102d, 102e of the connector housing 102, respectively. The support blocks 122 of each pair of support blocks 122 can be laterally spaced from one another, such that the opposed facing surfaces 122a of a respective pair of support blocks 122, in cooperation with the respective upper or lower surface 102d, 102e of the connector housing 102, define a channel 124 between the support blocks 122. It should be appreciated, however, that the support members 120 can have other configurations, as desired. For example, the support members 120 can be configured as apertures that extend into the surfaces 102d and 102e such that the spacer members 300 are press fit into the apertures.

The channel 124 defined between each respective pair of support blocks 122 can be configured to receive and captively retain at least a portion of a corresponding one of the spacer members 300, thereby removably coupling the spacer member 300 to the connector housing 102. For instance, in accordance with the illustrated embodiment, the facing surfaces of a pair of support blocks 122 can be angularly offset with each other and with respect to the upper and lower surfaces 102d, 102e of the connector housing 102, such that the channel 124 defined therebetween has a generally trapezoidal cross section configured to receive a complementarily shaped portion of a respective spacer member 300, the lateral spacing between the upper ends of the respective facing surfaces of the support blocks 122 narrower than that of the lower ends. The illustrated connector housing 102 includes four support members 120. More specifically, a first pair of support blocks 122 extends from the upper surface 102d of the connector housing 102 proximate a first side 102c of the connector housing 102. A second pair of support blocks 122 extends from the lower surface 102e of the connector housing 102 proximate the first side 102c of the connector housing 102, the first pair of support blocks 122 aligned along the transverse direction T with respect to the second pair of support blocks 122. A third pair of support blocks 122 extends from the upper surface 102d of the connector housing 102 proximate a second side 102c of the connector housing 102 that is opposite the first side 102c. A fourth pair of support blocks 122 extends from the lower surface 102e of the connector housing 102 proximate the second side 102c of the connector housing 102, the third pair of support blocks 122 aligned along the transverse direction T with respect to the fourth pair of support blocks 122. Each support block defines a rear end 120b that is substantially coplanar with the rear end 102b of the connector housing and an opposed front end 120a that is defined longitudinally forward of the rear end 102b and longitudinally rearward of the front end 102a of the connector housing 102.

Each of the illustrated spacer members 300 has a generally “T” shaped body 301 that extends between a front end 301a and an opposed rear end 301b. The body 301 of each spacer member 300 can comprise a coupling bar 302 configured to be received in a corresponding one of the channels 124 and a cross bar 304 that is oriented substantially perpendicular to the coupling bar 302. The coupling bar 302 of each spacer member 300 can define a substantially trapezoidal cross section configured to be slidably received in a corresponding one of the channels 124 in a clearance fit, so that each spacer member 300 can be received in a corresponding channel 124 along the longitudinal direction L or otherwise seated against the at least one support member 120. Because the trapezoidal cross section of the coupling bar is narrower at the top than at the bottom, the coupling bar 302 of each spacer member 300 will be captively retained within a respective channel 124, and will be constrained from moving along the transverse or lateral directions with respect to the connector housing 102. When each spacer member 300 is fully inserted into a respective one of the channels 124 or otherwise seated against a respective support member, the rear or inner face 304b of the cross bar 304 can abut respective surfaces of the front ends 120a of the support blocks 122.

The cross bar 304 of each spacer member 300 can define a front, or panel facing, face 304a that is opposite the rear faces 304b. Each spacer member 300 can further include an engagement surface that defines the front face 304a and is configured to make contact with a corresponding portion of the rear surface 202b of the panel 200, for instance when a force is applied to the panel mount electrical connector 100 and/or the panel 200 that causes the panel mount electrical connector 100 to move forward relative to the panel 200 and/or causes the panel 200 to move rearward relative to the panel mount electrical connector 100. The front and rear faces 304a-b can also be referred to as first and second opposed outermost surfaces of the cross bar 304, the first and second opposed outermost surfaces spaced apart from each other along the insertion direction I. In accordance with the illustrated embodiment, the cross bar 304 has a cross bar thickness TC defined by the front and rear faces 304a-b, or first and second outermost surfaces, of the cross bar 304. The cross bar 304 of each spacer member 300 has a width W defined by opposed sides 304c and a height H defined by opposed upper and lower surfaces of the cross bar 304. The width W of the cross bar 304 can be configured such that the cross bar 304 of the spacer member 300 will fit through a respective spacer gap 117 in the upper or lower wall portions 116d, 116e of the connector housing 102 when the spacer member 300 is removably coupled to the connector housing 102.

The spacer members 300 can be configured to facilitate removable attachment of the panel mount electrical connector 100 to a panel 200 having a predetermined thickness TP. For example, the size of the gap G that extends between the first and second retention members 114 and 115 can be determined by the distance along the longitudinal direction L between the front faces 304a of the cross bars 304 and the rear surfaces 118a of the tabs 118 when the spacer member is seated against the support member 120. In accordance with the illustrated embodiment, the size of the gap G can be determined by a spacer thickness TS defined by the front and rear ends 301a, 301b of the body 301, for instance as the distance therebetween along the longitudinal direction L. The size of the gap G can be broadened or narrowed by increasing or decreasing the spacer thickness TS.

In accordance with the illustrated embodiment, the spacer thickness can be varied by increasing or decreasing the thickness TC of the cross bar 304, defined by the front and rear faces 304a-b, for instance as the distance therebetween along the longitudinal direction L. Thus, a plurality of spacer members 300 can be provided with the panel mount electrical connector 100. In accordance with an embodiment, each spacer member 300 of the plurality can have a coupling bar 302 constructed substantially identically to that of the other spacer members 300 of the plurality, and can have cross bar thicknesses TC that are the same or different. A spacer member of a particular cross bar thickness TC, and thus defining a particular spacer thickness TS, can be selected to define a desired sized gap G between the tabs 118 of the connector housing 102 and the spacer members 300. Therefore, it can be said the at least one second retention member 115 having a front face located at a position that is spaced from the first retention member 114 along the insertion direction so as to define the gap G from the front face to the first retention member and that the position of the front face is adjustable so that the gap G is correspondingly adjustable. Each engagement surface that defines the front face 304a of the spacer members 300 can have a position that differs with respect to the position of the front face 304a of at least one other of the plurality of spacer members 300 when seated against the support member.

It should be appreciated that the panel mount electrical connector is not limited to the at least one second retention member 115 having the spacer members 300. For example, in an alternative embodiment, the at least one second retention member 115 can include a spacer member provided in the form of a ratcheting spacer member. The ratcheting spacer member can be constructed substantially similarly to the spacer member 300, but with a coupling bar that supports first ratchet members, such as a first plurality of ratchet teeth, that are configured to engage with complementary second ratchet members, such as a second plurality of ratchet teeth, that are supported by the support blocks 122. The teeth of the first and second pluralities of ratchet teeth can be spaced so as to engage one another at predetermined distances along the longitudinal direction L, thereby defining predetermined incremental gaps G as the ratcheting spacer member is advanced into a respective one of the ratcheting channels moving front to rear with respect to the connector housing 102. The ratcheting spacer member can be configured such that it can be advanced front to back with respect to the connector housing 102, but can not be backed out of the ratcheting channel in a direction opposite to the direction along which it was advanced. In such an embodiment as with the illustrated embodiment, the position of the front face can be considered adjustable so that the gap is correspondingly adjustable.

In accordance with an embodiment, a panel mount electrical connector kit can be provided. The panel mount electrical connector kit can include at least one connector housing 102, and a plurality of spacer members 300. At least one of the spacer members 300 of the plurality can have a first spacer thickness TS that is different from that of a second spacer member 300 of the plurality. For example, the panel mount electrical connector kit can include a first plurality of spacer members 300 having a first spacer thickness TS, such that when the first plurality of spacer members 300 are removably coupled to the connector housing 102, the panel mount electrical connector can be removably attached to a panel 200 having a first thickness TP. The panel mount electrical connector kit can further include a second plurality of spacer members 300 having a second spacer thickness TS that is different from the first thickness of the first plurality of spacer members 300, such that when the second plurality of spacer members 300 are removably coupled to the connector housing 102, the panel mount electrical connector can be removably attached to a panel 200 having a second thickness TP that is different from the first thickness of the first panel 200.

The gap G can be sized so as to retain the panel 200 to between the tabs 118 and the spacer members 300 and to allow the panel to “float” between the tabs 118 and the spacer members 300. More specifically, the gap G can be sized to comprise a floating gap that includes the thickness TP of the panel 200 plus at least one or both of an additional distance along the longitudinal direction L between the front surface 200a of the panel 200 and the rear surface 118a of the tabs and an additional distance along the longitudinal direction L between the rear surface 200b of the panel 200 and the front face 304a of the cross bars 304 of the spacer members 300.

The panel mount electrical connector 100 can further include at least one alignment member 126, the alignment member 126 configured to aid in aligning the panel mount electrical connector 100 with respect to the opening 202 in the panel 200 as the connector housing 102 is inserted into the opening 202. In accordance with the illustrated embodiment, the connector housing 102 further includes an alignment member 126 in the form of a rib 128 extending laterally from the left side end 102c of the connector housing 102. The rib 128 can be sized to be received in a complementary alignment slot 206 defined by the opening 202 in the panel 200 when the panel mount electrical connector 100 is operated from an inserted position to a retained position with respect to the panel 200, as described in more detail below. The illustrated rib 128 can also rest in the alignment slot 206 when the panel mount electrical connector is in a retained position relative to the panel 200.

Referring now to FIGS. 1A-C and 4A-B, the panel mount electrical connector 100 can further include at least one locking member 400, the locking member 400 configured to prevent removal of the panel mount electrical connector 100 from the panel 200, for instance by preventing the panel mount electrical connector 100 and/or the panel 200 from moving with respect to each other along the lateral direction A, thereby preventing the tabs 118 from re-aligning with the locating slots 204 once the panel mount electrical connector 100 has been removably attached to the panel 200. The locking member 400 can be supported by the connector housing 102. For example, the illustrated connector housing can include a locking member pocket 130 extending from the right side end 102c of the housing body 103, the pocket 130 configured to support the locking member 400 such that the locking member 400 can be operated between respective released and locked positions relative to the housing body 103 and the panel 200 by causing the locking member to move along the longitudinal direction L.

In accordance with the illustrated embodiment, the locking member 400 has a generally rectangular shaped body 402 that defines a front end 402a, an opposed rear end 402b, and opposed upper and lower ends 402c, 402d. The upper and lower ends 402c, 402d of the body 402 defines resilient upper and lower cantilevered latch arms 404, 406, respectively. The upper latch arm 404 can be cantilevered with respect to the rear end 402b of the body 402, and can be at least partially defined by a corresponding upper slot 410 extending through the body 402 along the lateral direction A. The lower latch arm 406 can be cantilevered with respect to the front end 402a of the body 402, and can be at least partially defined by a corresponding lower slot 412 extending through the body 402 along the lateral direction A. The distal ends of the upper and lower latch arms 404, 406 can define respective wedge shaped upper and lower latch members 414, 416, the latch members configured to engage complementary latch engaging members defined by the pocket 130, as described in more detail below. The body 402 can further include a button 418 extending upward from the upper end 402c, the button 418 configured to receive a force applied thereto, and to transmit the force to the body 402, thereby causing the locking member 400 to operate from the released position to the locked position.

In accordance with the illustrated embodiment, the pocket 130 can extend from the right side end 102c of the housing body 103. The illustrated pocket can include a side wall 130a spaced from the right side end 102c of the connector housing, a pair of upper and lower front walls 130b, 130c that are spaced rearward from the front end 102a of the connector housing 102 and that are aligned with each other and spaced apart from each other along the transverse direction T, a first latch engaging member 132 aligned with the upper front wall 130b along the longitudinal direction L and spaced rearward from the upper front wall 130b, and a second latch engaging member 134 aligned with the lower front wall 130c along the longitudinal direction L and disposed proximate the rear end 102b of the connector housing. The upper and lower front walls 130b, 130c, and the first and second latch engaging members 132, 134 can extend between the side wall 130a and the right side end 102c of the connector housing 102, thereby defining a body receiving space 136 configured to support the body 402 of the locking member 400, an upper latch member receiving space 138 configured to receive the upper latch member 414, and a lower latch member receiving space 140 configured to receive the lower latch member 416. In accordance with the illustrated embodiment, the pocket 130 can be integral with housing body 103, and more particularly with portions of 116c, 116d, and 116e.

In operation, the front end 402a of the locking member 400 can be inserted into the rear end of the pocket 130. As the body 402 of the locking member 400 advances forward into the body receiving space 136, the angled surface of the lower latch member 416 will make contact with the rear and upper surfaces of the second latch engaging member 134. The angled surface of the lower latch member 416 will ride along the upper surface of the second latch engaging member 134, thereby causing the lower latch arm 406 to deflect inward with respect to the body 402. When the lower latch member 416 advances past the front edge of the second latch engaging member 134, the lower latch arm 406 will snap back to its non-deflected position and the lower latch member 416 will be disposed in the lower latch member receiving space 140. The rear edge of the lower latch member 416 can act to prevent the locking member 400 from backing out of the pocket 130. With the lower latch member 416 disposed in the lower latch member receiving space 140, the locking member is supported by the pocket 130, and is in the released position relative to the connector housing 102.

The locking member 400 can be operated from the released position to the locked position by applying a force to the body, for instance the button 418, that causes the locking member to advance further forward with respect to pocket 130. As the body 402 of the locking member 400 advances further forward into the body receiving space 136, the angled surface of the upper latch member 414 will make contact with the rear and lower surfaces of the first latch engaging member 132. The angled surface of the upper latch member 414 will ride along the lower surface of the second latch engaging member 134, thereby causing the upper latch arm 404 to deflect inward with respect to the body 402. When the upper latch member 414 advances past the front edge of the first latch engaging member 132, the upper latch arm 404 will snap back to its non-deflected position and the upper latch member 414 will be disposed in the upper latch member receiving space 138. The rear edge of the upper latch member 414 can act to retain the locking member 400 in the locked position. The locking member 400 can be operated from the locked position to the released position by causing the upper latch arm 404 to be deflected inward with respect to the body 402, such that the upper latch member 414 can pass below the first latch engaging member 132. With the locking member 400 in the locked position, the locking member can act to prevent the panel mount electrical connector 100 and the panel 200 form moving with respect to each other along the lateral direction A, as described in more detail below. It should be appreciated that the panel mount electrical connector 100 is not limited to the illustrated locking member 400 and/or pocket 130, and the that the panel mount electrical connector 100 can alternatively be constructed with any other suitable locking member and/or locking member support structures as desired.

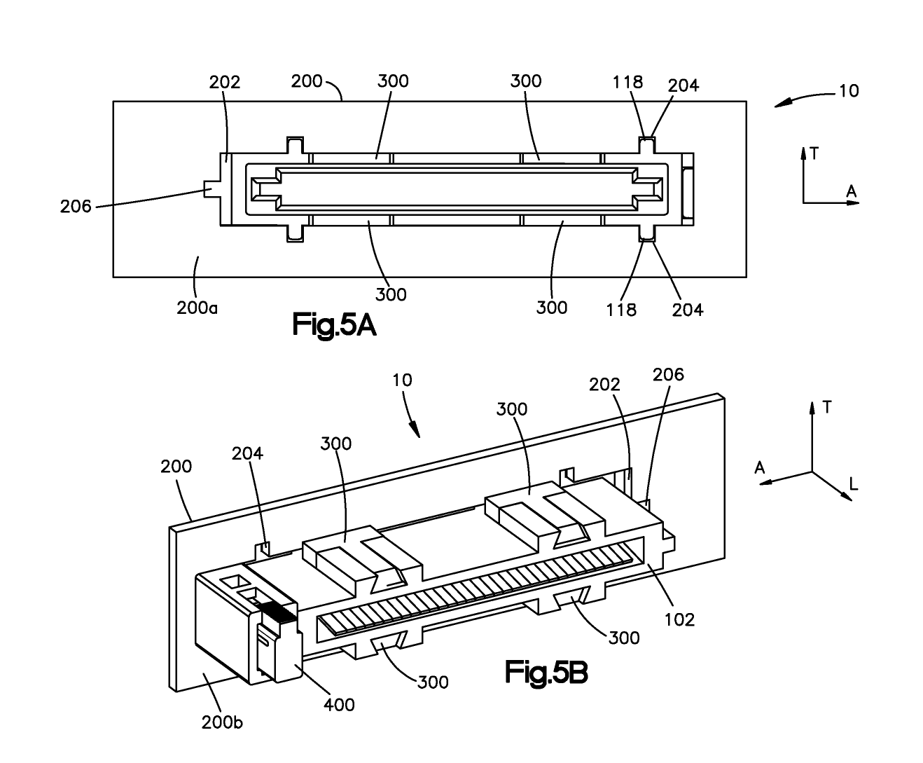

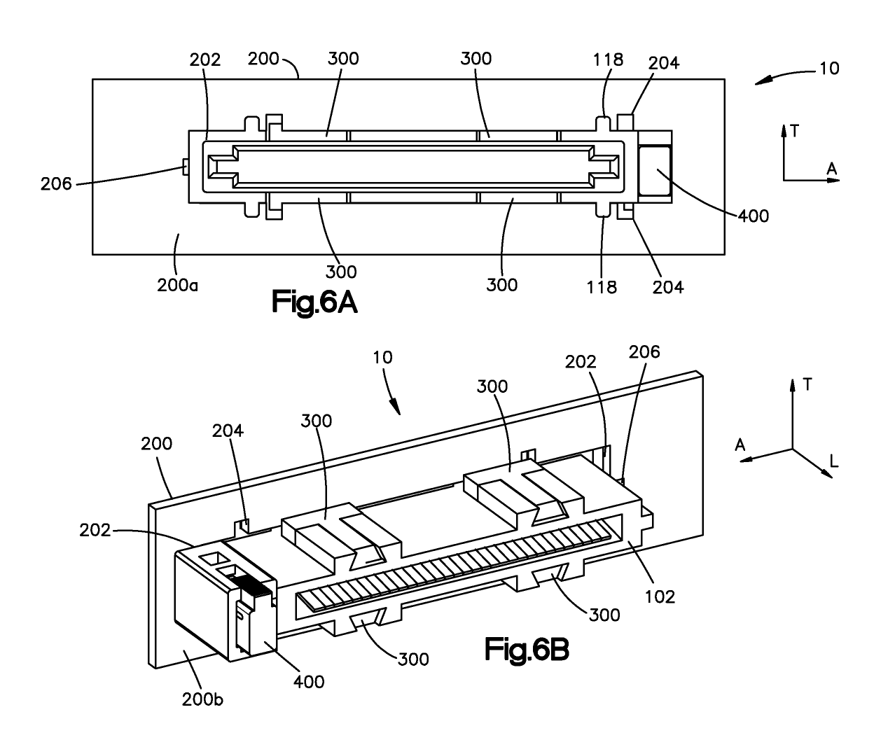

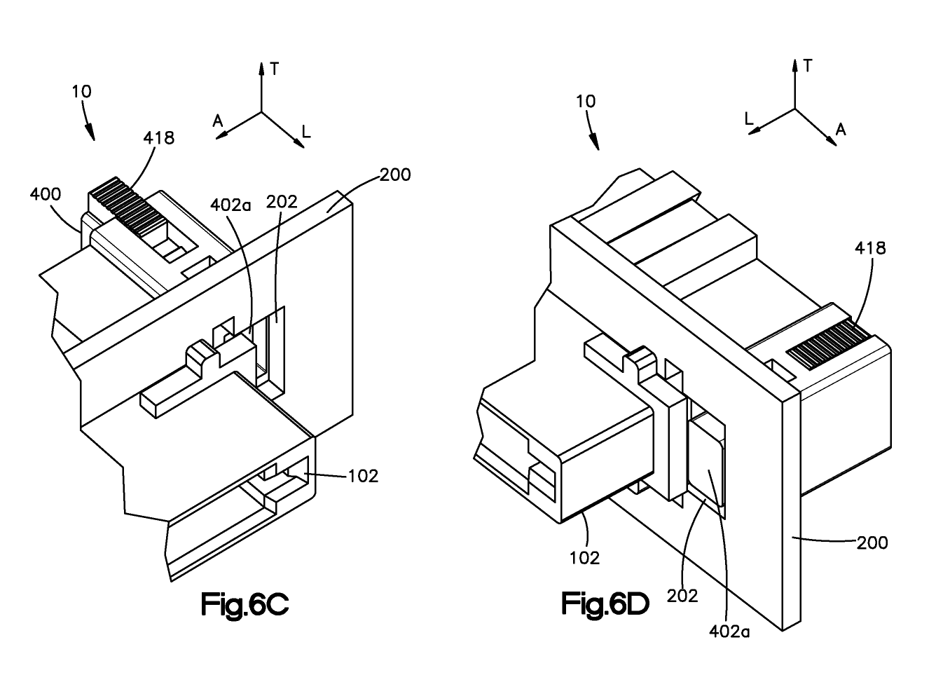

Referring generally to FIGS. 5A-6D, the steps of removably attaching the panel mount electrical connector 100 to panel 200 are illustrated. Referring now to FIGS. 5A-B, in accordance with the illustrated embodiment, four spacer members 300 can be selected based upon the thickness TP of the panel 200. For instance, spacer members 300 can be selected that have respective spacer thicknesses TS that will define a gap G between the tabs 118 and the spacer members 300 sufficient to retain the panel 200 therebetween. Each spacer member 300 can be removably coupled to the connector housing 102 by placing the spacer member 300 against the upper or lower surface 102d, 102e of the connector housing 102, and sliding the spacer member 300 along the longitudinal direction L such that the cross bar 304 passes through the respective spacer gap 117 and into a respective one of the channels 124. It should be appreciated that if the panel mount electrical connector 100 is subsequently removed from the first panel 200 to which it is removably attached and is to be inserted into and removably attached to a second panel 200 having a different thickness than the first panel, that four other spacer members 300 having different thicknesses can be selected and removably coupled to the connector housing 102 in order to define a second gap G that is sized to capture the second panel.

If the connector housing 102 is not already supporting a locking member 400, a locking member 400 can be inserted into a released position within the pocket 130 as described above. The assembled panel mount electrical connector 100 can then be inserted into the opening 202 in the panel 200. The front end 102a of the connector housing can be inserted into the opening 202, with the tabs 118 aligned with respective ones of the locating slots 204. The connector housing 102 can be advanced into the opening such that the tabs 118 pass through the locating slots 204, and advanced until the rear surface 200b of the panel 200 abuts the front faces 304a of respective ones of the spacer members 300. With the panel mount electrical connector 100 inserted into the opening 202 such that the panel 200 is disposed between the tabs 118 and the spacer members 300, the panel mount electrical connector 100 is in the inserted position relative to the panel 200, and can operated from the inserted position to the retained position.

Referring now to FIGS. 6A-B, the panel mount electrical connector 100 can be operated from the inserted position to the retained position by causing the connector housing 102 to move along a locking direction that is parallel to the lateral direction A and perpendicular to the insertion direction, such that the tabs 118 move to the side of the locating slots 204, and the rib 128 is received in the locating slot 204. With the panel mount electrical connector 100 in the retained position, the panel mount electrical connector 100 and the panel 200 can be prevented from moving with respect to each other along the longitudinal direction L. For example, if a force is applied to the panel mount electrical connector 100 and/or the panel 200 that causes the panel mount electrical connector 100 to move rearward relative to the panel and/or causes the panel 200 to move forward relative to the panel mount electrical connector 100, the front surface 200a of the panel 200 can make contact with the rear surfaces 118a of one or more of the tabs 118, thereby preventing further movement of the panel mount electrical connector 100 relative to the panel 200. Additionally, respective portions of the front surface 200a of the panel 200 proximate the alignment slot 206 can make contact with one or more rear surfaces of respective portions of the corresponding side wall portion 116c that are proximate the rib 128, thereby preventing further movement of the panel mount electrical connector 100 relative to the panel 200. In other words, the respective portions of the corresponding side wall portion 116c can act as retention members 114.

Similarly, if a force is applied to the panel mount electrical connector 100 and/or the panel 200 that causes the panel mount electrical connector 100 to move forward relative to the panel and/or causes the panel 200 to move rearward relative to the panel mount electrical connector 100, the rear surface 200b of the panel 200 can make contact with the front faces 304a of one or more of the spacer members 300, thereby preventing further movement of the panel mount electrical connector 100 relative to the panel 200.

Referring now to FIGS. 6C-D, with the panel mount electrical connector 100 in the retained position, the panel mount electrical connector 100 and the panel 200 can move with respect to each other along the lateral direction L. In order to secure the panel mount electrical connector in the retained position relative to the panel, the locking member 400 can be operated from the released position to the locked position. With the panel mount electrical connector 100 in the retained position, the front end 402a of the locking member 400 can be disposed rearward of the rear surface 200b of the panel, and aligned with the rightmost side of the opening 202. When the locking member 400 is operated from the released position to the locked position as described above, the front end 402a of the locking member 400 can advance into the rightmost side of the opening 202 such that the front end 402a of the locking member 400 is disposed in the opening 202, between the front and rear surfaces 200a, 200b of the panel, or beyond the front surface 200a of the panel 200. Accordingly, with the panel mount electrical connector 100 in the retained position relative to the panel 200 and with the locking member 400 operated to the locked position, the panel mount electrical connector 100 and the panel 200 are prevent from moving relative to one another along the lateral direction A, and the panel mount electrical connector 100 is thus securely attached relative to the panel 200. It should be appreciated that the panel mount electrical connector 100 can be removed from the panel 200 by operating the locking member 400 from the locked position to the released position, and by operating the panel mount electrical connector 100 from the retained position to the inserted position.

A method of mounting the panel mount electrical connector 100 to a panel 200 can include the step of providing or teaching the use of a panel mount electrical connector 100 having a connector housing 102 and at least one electrical contact 104 supported by the connector housing 102, at least one first retention member 114, and a plurality of second retention members 115, each second retention member 115 of the plurality configured to be removably coupled to the connector housing 102. At least a first one of the second plurality of retention members 115 can define a first gap G with respect to the first retention member 114 when the at least a first one of the second plurality of retention members 115 is coupled to the connector housing 102. Further, at least a second one of the plurality of second retention members 115 can defines a second gap G when the at least a second one of the plurality of second retention members 115 is coupled to the connector housing 102. The first gap G can be less than a thickness TP of the panel 200 and the second gap G can be at least equal to the thickness TP of the panel 200. The method can further include teaching the step of coupling the at least a second one of the plurality of second retention members 115 to the connector housing 102 so as to define the second gap G between the at least one first retention member 114 and the at least a second one of the plurality of second retention members 115. The method can further include teaching the step of mounting the electrical connector 102 to the panel 200 such that the panel 200 is captured in the second gap G.

Although the panel mount electrical connector has been described herein with reference to preferred embodiments and/or preferred methods, it should be understood that the words which have been used herein are words of description and illustration, rather than words of limitation, and that the scope of the instant disclosure is not intended to be limited to those particulars, but rather is meant to extend to all structures, methods, and/or uses of the herein described panel mount electrical connector. Those skilled in the relevant art, having the benefit of the teachings of this specification, may effect numerous modifications to the panel mount electrical connector as described herein, and changes may be made without departing from the scope and spirit of the instant disclosure, for instance as recited in the appended claims.

What is claimed:

1. An electrical connector configured to be coupled to a panel that defines an opening, the electrical connector comprising:
a connector housing that is configured to be inserted into the opening of the panel along an insertion direction so as to define an inserted position, the connector housing defining opposed surfaces that are spaced from each other along a direction that is perpendicular to the insertion direction, the connector housing including at least one first retention member that extends from at least one of the opposed surfaces;
at least one electrical contact supported by the connector housing; and
at least one second retention member at least partially supported by the connector housing, the at least one second retention member having a front face located at a position that is spaced from the first retention member along the insertion direction so as to define a gap from the front face to the first retention member, the gap sized to capture the panel between the front face and the first retention member when the connector housing is in the inserted position, wherein the position of the front face is adjustable so that the gap is correspondingly adjustable.

2. The electrical connector of claim 1, wherein the second retention member includes at least one support member and a spacer member configured to be seated against the at least one support member, the spacer member defining an engagement surface that defines the front face when the spacer member is seated against the at least one support member.

3. The electrical connector of claim 2, wherein the spacer member is removable from the at least one support member.

4. The electrical connector of claim 3, wherein the spacer member is a select spacer member among a plurality of spacer members each having a respective engagement surface that defines the front face whose position differs with respect to the position of the front face of at least one other of the plurality of spacer members when seated against the at least one support member.

5. The electrical connector of claim 2, wherein the at least one support member defines a channel configured to receive the spacer member such that the spacer member is seated against the at least one support member.

6. The electrical connector of claim 5, wherein the at least one support member comprises first and second support blocks spaced apart from each other along a direction that is substantially perpendicular to the insertion direction so as to define a channel that extends from the first support block to the second support block along the direction that is perpendicular to the insertion direction.

7. The electrical connector of claim 3, wherein the at least one support member defines a channel configured to receive the spacer member such that the spacer member is seated against the at least one support member.

8. The electrical connector of claim 1, wherein the connector housing further comprises at least one retention tab that extends out from the at least one first retention member along a second direction that is substantially perpendicular to the insertion direction, the retention tab configured to be received in a locating slot of the panel when the connector housing is inserted into the opening.

9. The electrical connector of claim 8, wherein the opposed surfaces comprise first and second surfaces that are spaced from each other along the second direction, and the at least one tab comprises a first tab that extends out along the second direction relative to the first surface and a second tab that extends out along the second direction relative to the second surface, the first and second tabs each configured to be received in a respective locating slot of the panel when the connector housing is inserted into the opening.

10. The electrical connector of claim 8, wherein the connector housing is moveable relative to the panel between the inserted position and a retained position, along a locking direction that is substantially perpendicular to both the insertion direction and the second direction after the retention tab has been inserted through the locating slot, so as to remove the at least one tab from alignment with the locating slot.

11. The electrical connector of claim 10, further comprising a locking member that is configured to be received in the opening in the panel when the connector housing is in the retained position so as to prevent movement of the connector housing from the retained position to the inserted position.

12. The electrical connector of claim 11, wherein the connector housing is configured to retain the locking member when the locking member is received in the opening.

13. The electrical connector of claim 12, wherein a first side of the connector housing is configured to retain the locking member, and a second side of the connector housing opposite the first side along the locking direction supports an alignment member that is configured to be received in an alignment slot defined by the panel when the connector housing is in the retained position so as to limit movement of the electrical connector relative to the panel in the second direction.

14. An electrical connector configured to be coupled to a panel that defines an opening, the electrical connector comprising:
a connector housing that is configured to be inserted along an insertion direction at least partially into the opening, the connector housing defining opposed surfaces are spaced from each other along a direction that is perpendicular to the insertion direction, the connector housing including at least one first retention member that extends from at least one of the opposed surfaces;
at least one electrical contact supported by the connector housing; and
a plurality of spacer members configured to be selectively coupled to the connector housing at the at least one of the opposed surfaces, each of the plurality of spacer members defining an inner surface and an engagement surface that is spaced from the inner surface along the insertion direction when the spacer members are coupled to the at least one of the opposed surfaces,
wherein each of the spacer members defines a thickness that extends from the inner surface to the engagement surface, and the thickness of at least a first one of the plurality of spacer members is different than the thickness of at least a second one of the plurality of spacer members, such that when the first one of the plurality of spacer members is coupled to the at least one of the opposed surfaces, a first gap is defined from the first retention member to the engagement surface of the first spacer member along the insertion direction, and when the second one of the plurality of spacer members is coupled to the at least one of the opposed surfaces, a second gap is defined from the first retention member to the engagement surface of the second spacer member along the insertion direction, the second gap different from the first gap.

15. The electrical connector of claim 14, wherein the connector housing includes at least one support member and each spacer member is configured to be seated against the at least one support member.

16. The electrical connector of claim 15, wherein the at least one support member defines a channel configured to selectively receive each spacer member such that the spacer member is seated against the at least one support member.

17. The electrical connector of claim 16, wherein the at least one support member comprises first and second support blocks spaced apart from each other along a direction that is substantially perpendicular to the insertion direction so as to define a channel that extends from the first support block to the second support block along the direction that is perpendicular to the insertion direction.

18. The electrical connector of claim 14, wherein the connector housing further comprises at least one retention tab that extends out from the at least one first retention member along a second direction that is substantially perpendicular to the insertion direction, the retention tab configured to be received in a locating slot of the panel when the connector housing is inserted into the opening.

19. The electrical connector of claim 18, wherein the connector housing is moveable relative to the panel between an inserted position and a retained position, along a locking direction that is substantially perpendicular to both the insertion direction and the second direction after the retention tab has been inserted through the locating slot, so as to remove the at least one tab from alignment with the locating slot.

20. The electrical connector of claim 19, further comprising a locking member that is configured to be received in the opening in the panel when the connector housing is in the retained position so as to prevent movement of the connector housing from the retained position to the inserted position.

21. An electrical connector configured to be coupled to a panel that defines an opening, the electrical connector comprising:
a connector housing that is configured to be inserted along an insertion direction at least partially into the opening to thereby define an inserted position, the connector housing defining a mating end, a mounting end, and opposed surfaces that extend between the mating end and the mounting end, the connector housing including at least one first retention member that extends from at least one of the opposed surfaces, and
at least one spacer member configured to be removably coupled to the connector housing such that the first and second retention members are spaced from each other along the insertion direction thereby define a gap that is sized to capture the panel between the first and second retention members when the connector housing is in the inserted position.

22. The electrical connector of claim 21, wherein the connector housing includes at least one support member and the at least one spacer member is configured to be seated against the at least one support member.

23. The electrical connector of claim 22, wherein the at least one support member defines a channel configured to selectively receive the at least one spacer member such that the spacer member is seated against the at least one support member.

24. The electrical connector of claim 23, wherein the at least one support member comprises first and second support blocks spaced apart from each other along a direction that is substantially perpendicular to the insertion direction so as to define a channel that extends from the first support block to the second support block along the direction that is perpendicular to the insertion direction.

25. A method of mounting an electrical connector to a panel, the method comprising the steps of:
coupling a spacer member to an electrical connector housing such that an engagement surface of the spacer member is spaced from a first retention member along an insertion direction so as to define a desired gap;
moving the electrical connector housing along the insertion direction into an opening defined by a panel so as to define an inserted position;
moving the electrical connector housing along a locking direction that is perpendicular to the insertion direction from the inserted position to a locking position to thereby trap the panel within the desired gap between the first retention member and the engagement surface.

26. The method of claim 25, wherein the coupling step comprises:
coupling a first spacer member to the electrical connector housing such that the engagement surface of the first spacer member is spaced from the first retention member along the insertion direction so as to define a first gap;
removing the first spacer member from the electrical connector housing; and
coupling a second spacer member to the electrical connector housing such that the engagement surface of the second spacer member is spaced from the first retention member along the insertion direction so as to define a second gap that has a dimension along the insertion direction that is different than that of the first gap.

27. The method of claim 26, further comprising the step of inserting a locking member into the opening of the panel so as to prevent the electrical connector housing from moving from the locked position toward the inserted position.

28. The method of claim 25, wherein the first moving step comprises moving the electrical connector along the insertion direction such that a retention tab that extends from the first retention member passes through a slot defined by the panel.

29. A method of mounting an electrical connector to a panel, the method comprising the steps of:
providing an electrical connector having a connector housing and at least one electrical contact supported by the connector housing, at least one first retention member, and a plurality of second retention members each configured to be removably coupled to the connector housing, wherein at least a first one of the plurality of second retention members defines a first gap with respect to the first retention member when the at least a first one of the plurality of second retention members is coupled to the connector housing, and at least a second one of the plurality of second retention members defines a second gap with respect to the first retention member when the at least a second one of the plurality of second retention members is coupled to the connector housing, wherein the first gap is less than a thickness of the panel and the second gap is at least equal to the thickness of the panel;
teaching the step of coupling the at least a second one of the plurality of second retention members to the connector housing so as to define the second gap between the at least one first retention member and the at least a second one of the plurality of second retention members; and
teaching the step of mounting the electrical connector to the panel such that the panel is captured in the second gap.
